(19) United States
(12) Patent Application Publication
(10) Pub. No.: US 2026/0153468 A1
(43) Pub. Date: Jun. 4, 2026

(54) Biological Information Sensing Device

(71) Applicant: METAL INDUSTRIES RESEARCH & DEVELOPMENT CENTRE, Kaohsiung City (TW)

(72) Inventors: Cheng-Yuan Zhou, Kaohsiung City (TW); Kuei-Ling Yeh, Kaohsiung City (TW); Yu-Sheng Lin, Kaohsiung City (TW); Ling-Zhen Kao, Tainan City (TW); Chun-Chieh Tseng, Kaohsiung City (TW); Shu-Hung Huang, Kaohsiung City (TW); Ping-Ruey Chou, New Taipei City (TW); Yen-Hsin Kuo, Kaohsiung City (TW)

(21) Appl. No.: 18/966,175

(22) Filed: Dec. 3, 2024

(51) Int. Cl. G01N 27/12; G01N 27/22

(52) U.S. Cl. CPC G01N 27/128; G01N 27/126; G01N 27/226

(57) ABSTRACT

A biological information sensing device includes an encapsulation layer including a sensing section for surrounding a to-be-tested object. A detection element is disposed in the sensing section and includes a plurality of electrodes parallel to and spaced from each other and forming two groups of electrodes which are alternatingly disposed, such that two adjacent electrodes are offset to the left or right, and projections of portions of the two adjacent electrodes overlap. A signal line on the left side of the plurality of electrodes is electrically connected to left offset electrodes. Another signal line on the right side of the plurality of electrodes is electrically connected to right offset electrodes. A signal transmission element is disposed on a side of the encapsulation layer opposite to the sensing section and includes at least one coil and two transmission lines electrically connected to the at least one coil and the signal lines.

### BACKGROUND OF THE INVENTION

### 1. Field of the Invention

The present invention relates to a biomedical detection technology and, more particularly, to a biological information sensing device for obtaining stable biomedical information with measurement accuracy.

### 2. Description of the Related Art

After surgery for repairing blood vessels, thrombus may occur and, thus, cause infection and necrosis of tissues. Therefore, the blood flow condition should be continuously monitored during the recovery time after surgery to immediately eliminate thrombus that may be formed. A conventional blood flow detection technology uses in vitro detection by a supersonic device held by medical personnel, and the blood flow condition is judged by analyzing the audio signal feedback. However, the operator must receive professional training, and the in vitro detection cannot be monitored continuously and requires repeated operations periodically, resulting in heavy labor burden on the medical personnel.

Another conventional blood flow sensing device may be implanted into a human body to conduct continuous detection on the blood vessels. The sensing device may transmit the blood flow signals to a monitoring equipment outside of the human body. However, the sensing device is shielded by the human tissues, and the detected blood flow change is weak, such that the blood flow signals are apt to be interfered by noise, leading to reduction in the detection accuracy and even erroneous diagnosis. As a result, the thrombus may not be treated timely, or unnecessary surgery may be performed due to erroneous diagnosis.

Thus, it is necessary to improve the conventional blood flow sensing device.

### BRIEF SUMMARY OF THE INVENTION

It is an objective of the present invention to provide a biological information sensing device which increases the change in capacitance and detection sensitivity.

It is another objective of the present invention to provide a biological information sensing device which increases the accuracy and reliability of biological detection.

It is a further objective of the present invention to provide a biological information sensing device which enhances the convenience and safety of use.

As used herein, the term “a”, “an” or “one” for describing the number of the elements and members of the present invention is used for convenience, provides the general meaning of the scope of the present invention, and should be interpreted to include one or at least one. Furthermore, unless explicitly indicated otherwise, the concept of a single component also includes the case of plural components.

A biological information sensing device according to the present invention includes an encapsulation layer, a detection element, and a signal transmission element. The encapsulation layer includes a sensing section configured to surround a to-be-tested object. The detection element is disposed in the sensing section of the encapsulation layer. The detection element includes a plurality of electrodes parallel to and spaced from each other and forming a left group of comb-shaped electrodes and a right group of comb-shaped electrodes alternatingly disposed with respect to the left group of comb-shaped electrodes, such that two adjacent electrodes are offset to left or offset to right, and projections of portions of the two adjacent electrodes overlap. Two signal lines are respectively located on a left side and a right side of the plurality of electrodes, such that one of the two signal lines on the left side is electrically connected to electrodes offset to the left, and another of the two signal lines on the right side is electrically connected to the electrodes offset to the right. The signal transmission element is disposed on a side of the encapsulation layer opposite to the sensing section. The signal transmission element includes at least one coil and two transmission lines electrically connected to the at least one coil. The two transmission lines are electrically connected to the two signal lines.

Therefore, in the biological information sensing device according to the present invention, by alternatingly arranging the plurality of electrodes to form plural capacitors connected in parallel, the total capacitance of the detection element may be significantly increased, such that the capacitance of the detection element may still change in response to weak biological information, thereby increasing the detection sensitivity. Furthermore, the stress conversion by the signal enhancing element causes uniform deformation of the dielectrics of the detection element, which increases the accuracy and reliability of detection.

In an example, each two adjacent electrodes have an overlap length and are spaced from each other by a spacing. The spacing and the overlap length define an overlap area. The two electrodes and the overlap area are equivalent to a capacitor. Thus, a capacitor in the form of parallel plates may be formed between two electrodes, thereby forming plural capacitors arranged close to each other.

In an example, when the number of the plurality of electrodes is n, n-1 capacitors are formed, and the capacitors are electrically connected in parallel by the two signal lines. Thus, the total capacitance of the detection element is equal to the sum of the capacitances of the plural capacitors, thereby increasing the magnitude of change in the capacitance and the detection sensitivity.

In an example, the spacing is 0.05-0.25 mm, and the overlap length is 1.5-5.8 mm. Thus, by selecting the specification of the plurality of electrodes of the detection element, the capacitance of the equivalent capacitor and the size of the detection element may be adjusted to suit to-be-tested objects of various sizes.

In an example, the detection element and the signal transmission element are made of biodegradable metal including magnesium, zinc, or iron. The encapsulation layer is made of biodegradable polymers including polyhydroxybutyrate (PHB) or poly(glycerol sebacate) (PGS). Thus, poisoning reaction or immune response will not occur while the biological information sensing device is located in the target organism, and the biological information sensing device may be degraded and absorbed after a period of time, thereby increasing the safety in use and reducing the burden of surgery.

In an example, the biological information sensing device further includes a signal enhancing element covering the plurality of electrodes of the detection element. The signal enhancing element includes a force application face facing the plurality of electrodes and a force reception face opposite to the force application face. The force reception face faces the to-be-tested object. Thus, the signal enhancing element may convert the dynamic change of the to-be-tested object into a force applied to the detection element, thereby increasing the accuracy and reliability of detection.

In an example, a plurality of particles is distributed on the force application face and is in contact with the plurality of electrodes and dielectrics in an area of the plurality of electrodes. Thus, the pressure withstood by the force reception face may be uniformly distributed between the plurality of electrodes via the plurality of particles, thereby ensuring deformation of the dielectrics and the change in the capacitance.

In an example, each of the plurality of particles has a width of 30-50 μm, and the distance between two adjacent particles is 40-60 μm. Thus, plural particles may be contacted in the area of the capacitor formed by two adjacent electrodes to uniformly apply force to the capacitor, thereby stabilizing the change of the capacitance.

In an example, each of the plurality of particles is a quadrilateral pyramid and has a height of 15-70 μm and a surface inclination angle of 30-70 degrees. Thus, each of the plurality of particles may gradually adjust the magnitude of deformation of the dielectrics according to the change of the magnitude of the force, thereby increasing the detection accuracy.

In an example, the signal enhancing element is made of biodegradable polymers including polyhydroxybutyrate (PHB) or poly(glycerol sebacate) (PGS). Thus, the signal enhancing element may be degraded and absorbed to avoid immune response, thereby increasing the safety of use and reducing the burden of surgery.

### DESCRIPTION OF THE DRAWINGS

The present invention will become more fully understood from the detailed description given hereinafter and the accompanying drawings which are given by way of illustration only, and thus are not limitative of the present invention, and wherein:

FIG. 1 is a perspective view of a biological information sensing device of a preferred embodiment according to the present invention.

FIG. 2 is a front, cross-sectional view of the biological information sensing device of the preferred embodiment according to the present invention.

FIG. 3 is an enlarged view of a circled portion A of FIG. 2.

FIG. 4 is a schematic view illustrating detection by the biological information sensing device of the preferred embodiment according to the present invention.

FIG. 5 is an enlarged view of a circled portion B of FIG. 4.

FIG. 6 is an enlarged cross-sectional view similar to FIG. 5, illustrating another example of the biological information sensing device according to the present invention.

FIG. 7 is an enlarged view of a signal enhancing element with quadrilateral pyramid particles according to the present invention.

FIG. 8 is an enlarged view of a signal enhancing element with cylindrical particles according to the present invention.

FIG. 9 is an enlarged view of a signal enhancing element with hemispherical particles according to the present invention.

When the terms “front”, “rear”, “left”, “right”, “up”, “down”, “top”, “bottom”, “inner”, “outer”, “side”, and similar terms are used herein, it should be understood that these terms have reference only to the structure shown in the drawings as it would appear to a person viewing the drawings and are utilized only to facilitate describing the invention, rather than restricting the invention.

### DETAILED DESCRIPTION OF THE INVENTION

In order to make the above and other objectives, features, and advantages of the present invention clearer and easier to understand, preferred embodiments of the present invention will be described hereinafter in connection with the accompanying drawings. Furthermore, the elements designated by the same reference numeral in various figures will be deemed as identical, and the description thereof will be omitted.

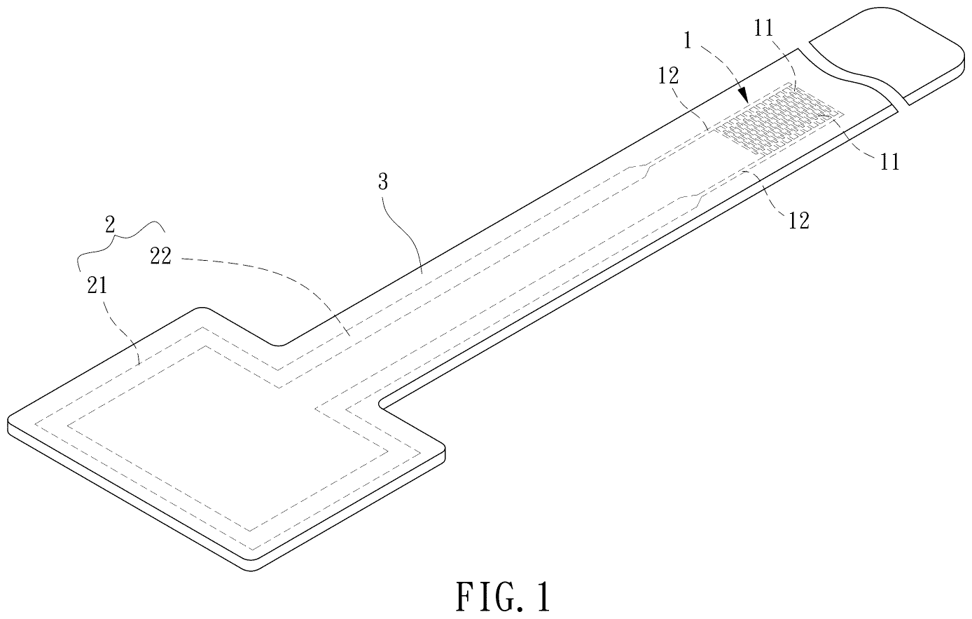

With reference to FIG. 1, a biological information sensing device of a preferred embodiment according to the present invention includes a detection element 1, a signal transmission element 2, and an encapsulation layer 3. The detection element 1 is coupled with the signal transmission element 2. The detection element 1 and the signal transmission element 2 are disposed in the encapsulation layer 3.

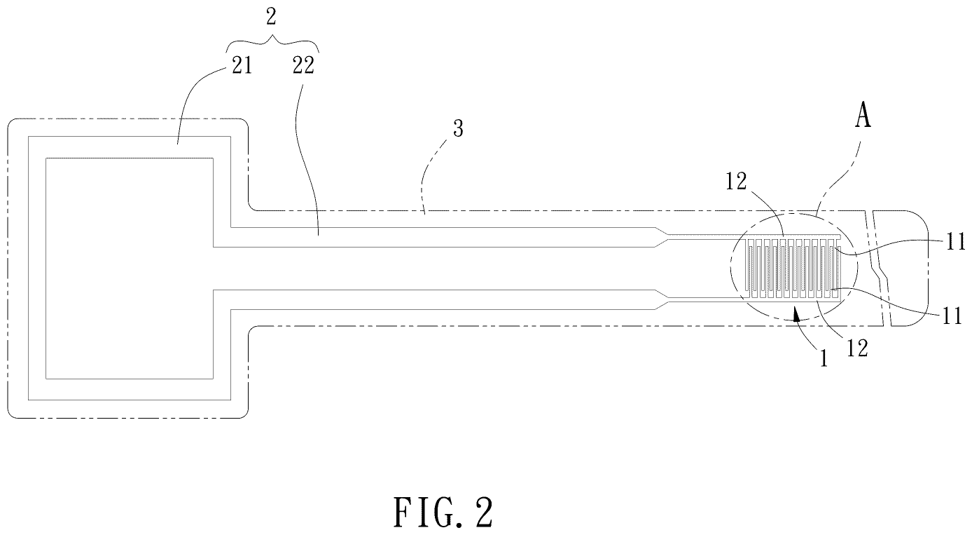

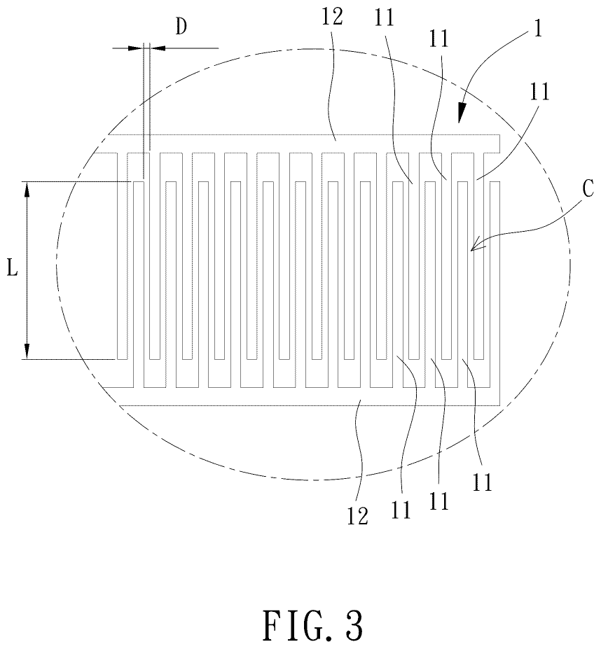

With reference to FIGS. 2 and 3, the detection element 1 includes a plurality of electrodes 11 each of which may be elongated. Furthermore, the plurality of electrodes 11 is preferably parallel to each other and alternatingly disposed on the same plane to form a left group of comb-shaped electrodes and a right group of comb-shaped electrodes alternatingly disposed with respect to the left group of comb-shaped electrodes. Specifically, two adjacent electrodes 11 are offset to the left or offset to the right, and projections of portions of the two adjacent electrodes overlap. Furthermore, the two adjacent electrodes 11 are spaced from each other by a spacing D in a vertical direction, such that the plurality of electrodes 11 form two groups of electrodes 11 offset to the left and offset to the right, respectively. Two electrodes 11 of the same group are spaced from each other by at least one electrode 11 of the other group and by a distance at least two times the spacing D. Furthermore, plural electrodes 11 of the same group are electrically connected to each other by a signal line 12. The two signal lines 12 and the plurality of electrodes 11 are preferably on the same plane. The two signal lines 12 may be two long, straight lines respectively located on a left side and a right side of the plurality of electrodes 11, such that one of the two signal lines 12 on the left side is electrically connected to the electrodes 11 offset to the left, and the other of the two signal lines 12 on the right side is electrically connected to the electrodes 11 offset to the right.

Since two adjacent electrodes 11 have an overlap length L and are respectively and electrically connected to two different signal lines 12, the two electrodes 11 and an overlap area C (defined by the spacing D and the overlap length L) may be equivalent to a capacitor. In a case that the number of the plurality of electrodes 11 is n, n-1 capacitors are formed, and the plural capacitors are electrically connected in parallel by the two signal lines 12, such that the total capacitance of the detection element 1 is equal to the sum of the capacitances of the plural capacitors. Namely, the total capacitance can be obtained by measuring the distal ends of the two signal lines 12.

With reference to FIG. 2, the signal transmission element 2 may be a planar antenna. The signal transmission element 2 includes at least one coil 21 which may be formed by winding a metal wire. In this embodiment, the signal transmission element 2 includes a rectangular coil 21. Nevertheless, the present invention is not limited to the quantity, shape, and number of coils of the above-mentioned at least one coil 21. Furthermore, the signal transmission element 2 may include two signal transmission lines 22 electrically connected to the at least one coil 21. The two signal transmission lines 22 are electrically connected to the two signal lines 12, respectively. Thus, the at least one coil 21 is electrically connected to the detection element 1 via the two signal transmission lines 22. Therefore, the electrical characteristics and the changes generated by the detection element 1 may be transmitted outward by the antenna formed by the at least one coil 21.

With reference to FIGS. 1 and 2, the encapsulation layer 3 is used to envelop the detection element 1 and the signal transmission element 2 to avoid electrically conductive metal materials from moisture, corrosion, and damage, thereby preventing adverse influence on the electrical characteristics and transmission of signals. The encapsulation layer 3 is preferably made of a high flex material to avoid the encapsulation layer 3 from breakage when the encapsulation layer 3 bends together with the detection element 1. Furthermore, the encapsulation layer 3 may be a multi-layer structure formed by layer-by-layer stacking, and the detection element 1 and the signal transmission element 2 may be disposed between two layers.

Furthermore, a portion of the encapsulation layer 3 aligned with an area between two adjacent electrodes 11 may be used as the dielectric of the capacitor. Specifically, the material of the encapsulation layer 3 in the overlap area C is located between two electrodes 11 to form a capacitor in the form of parallel plates. The capacitance of the capacitor is directly proportional to the overlap length L and the permittivity of the dielectric and is inversely proportional to the spacing D. Thus, the total capacitance of the detection element 1 can be increased by the more overlapping of two adjacent electrodes 11, the closer the electrodes, the higher the permittivity of the material of the encapsulation layer 3, and the higher quantity of the electrodes 11. When the dielectrics in the detection element 1 are subject to an external force and, thus, cause a change in the capacitance, the change may be up to several times the capacitance and, thus, may be detected more easily, thereby increasing the detection sensitivity.

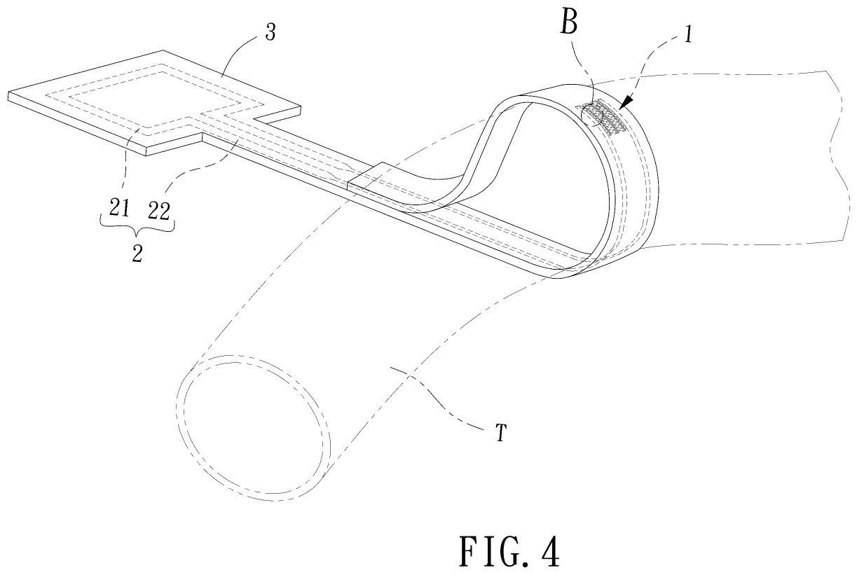

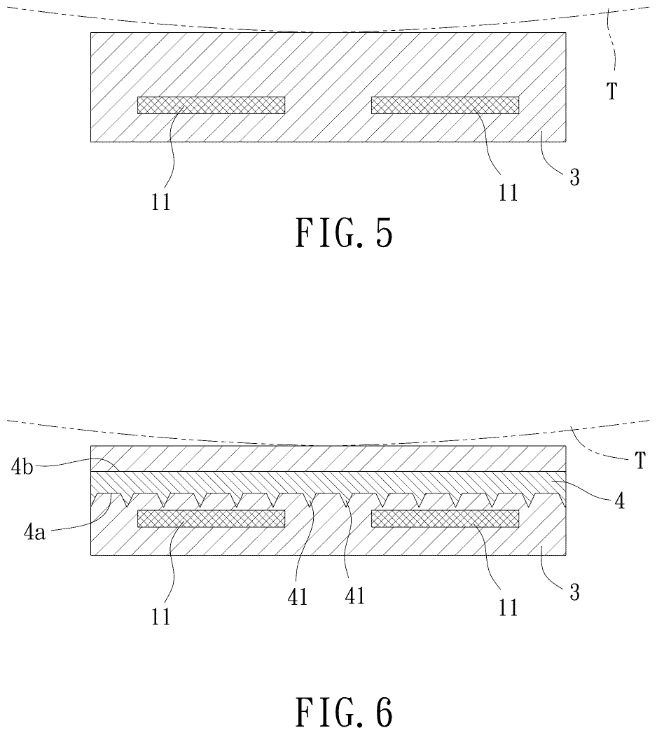

With reference to FIGS. 4 and 5, during detection, a section of the encapsulation layer 3 enveloping the detection element 1 surrounds a to-be-tested object T. In this embodiment, the to-be-tested object T may be a blood vessel. The signal transmission element 2 and the other portion of the encapsulation layer 3 may be implanted under the skin. Thus, when blood flows, the vibrations of the blood vessel wall can be transmitted to the detection element 1, such that the capacitance of the detection element 1 changes. Then, a reading device (not shown) is placed near the signal transmission element 2 and provides electromagnetic waves, such that the antenna of the signal transmission element 2 is energized to synchronize the changes of the capacitance of the detection element 1, and corresponding electromagnetic wave signals are transmitted back. By analyzing the signals received by the reading device, information associated with the blood flow can be obtained to assist in diagnosis of whether thrombus or other abnormal symptoms exist. The to-be-tested object T may be any living organs or tissues. The present invention is not limited to the above-mentioned blood vessel.

With reference to FIG. 6, the biological information sensing device according to the present invention may further include a signal enhancing element 4. The signal enhancing element 4 may cover the plurality of electrodes 11 of the detection element 1. Specifically, the signal enhancing element 4 includes a force application face 4a facing the plurality of electrodes 11 and a force reception face 4b opposite to the force application face 4a. The force reception face 4b faces the to-be-tested object T. Thus, when the to-be-tested object T vibrates, the signal enhancing element 4 receives the vibrations by the force reception face 4b. Then, the force application face 4a applies pressure to the dielectrics between the plurality of electrodes 11 to cause deformation. Furthermore, a plurality of particles 41 may be distributed on the force application face 4a. The plurality of particles 41 may be in direct contact with the plurality of electrodes 11 and the dielectrics in the area of the plurality of electrodes 11. Therefore, the pressure withstood by the force reception face 4b is uniformly distributed between the plurality of electrodes 11 via the plurality of particles 41. As a result, the dielectrics between the plurality of electrodes 11 may deform reliably, and the magnitude of the change of the capacitance of the detection element 1 is increased, thereby increasing the accuracy and reliability of detection.

With reference to FIGS. 3 and 6, each of the plurality of electrodes 11 may have a length preferably of 2-6 mm and a width preferably of 0.1-0.3 mm. The spacing D is preferably 0.05-0.25 mm, and the overlap length L is preferably 1.5-5.8 mm. The quantity and size of the electrodes 11 of the detection element 1 may be selected according to the size and shape of the to-be-tested object T, such that the detection element 1 may detect the whole to-be-tested object T. Furthermore, each of the plurality of particles 41 has a width preferably of 30-50 μm, and the distance between two adjacent particles 41 is preferably 40-60 μm. By the above specification, a capacitor formed by two adjacent electrodes 11 may be in contact with at least sixteen particles 41 and at most about three hundred particles 41.

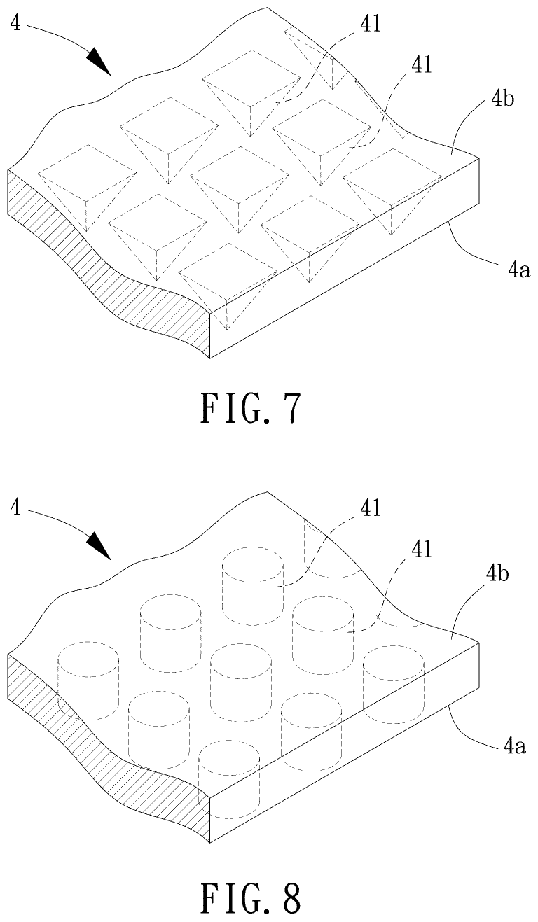

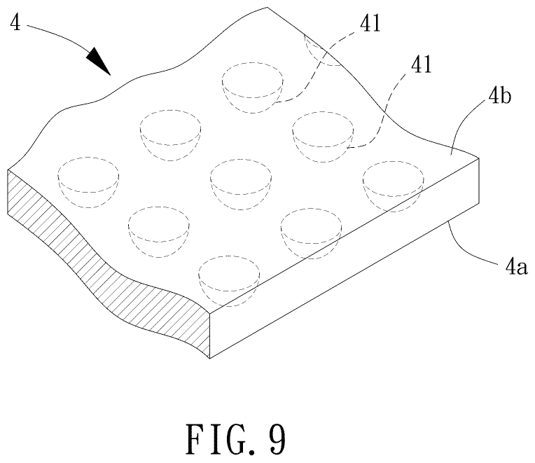

With reference to FIGS. 7-9, each of the plurality of particles 41 may be in the form of a cylinder, pyramid, frustum, or hemisphere, and the base of the cylinder, pyramid, or frustum may be circular, rectangular, triangular, or any other polygonal shape. The present invention is not limited to the form of the plurality of particles 41. Furthermore, the width is defined by the diameter, the longest side, or the longest diagonal of the base. Each of the plurality of particles 41 has a height preferably of 15-70 μm, and a surface inclination angle of the pyramid and the frustum may be 30-70 degrees.

Furthermore, the biological information sensing device according to the present invention is preferably made of biodegradable polymers, such that poisoning reaction or immune response will not occur while the biological information sensing device is located in the target organism. Furthermore, the biological information sensing device will be degraded and absorbed after a period of time without further surgery for removal, thereby avoiding the risks of further surgery. The detection element 1 and the signal transmission element 2 may be made of biodegradable metal, such as magnesium, zinc, and iron. The encapsulation layer 3 and the signal enhancing element 4 may be made of biodegradable polymers, such as polyhydroxybutyrate (PHB) and poly(glycerol sebacate) (PGS).

In summary, in the biological information sensing device according to the present invention, by alternatingly arranging the plurality of electrodes to form plural capacitors connected in parallel, the total capacitance of the detection element may be significantly increased, such that the capacitance of the detection element may still change in response to weak biological information, thereby increasing the detection sensitivity. Furthermore, the stress conversion by the signal enhancing element causes uniform deformation of the dielectrics of the detection element, which increases the accuracy and reliability of detection.

Although the present invention has been described with respect to the above preferred embodiments, these embodiments are not intended to restrict the present invention. Various changes and modifications on the above embodiments made by any person skilled in the art without departing from the spirit and scope of the present invention are still within the technical category protected by the present invention. Accordingly, the scope of the present invention shall include the literal meaning set forth in the appended claims and all changes which come within the range of equivalency of the claims.

What is claimed is:

1. A biological information sensing device comprising:
an encapsulation layer including a sensing section configured to surround a to-be-tested object;
a detection element disposed in the sensing section of the encapsulation layer, wherein the detection element includes a plurality of electrodes parallel to and spaced from each other and forming a left group of comb-shaped electrodes and a right group of comb-shaped electrodes alternatingly disposed with respect to the left group of comb-shaped electrodes, such that two adjacent electrodes are offset to left or offset to right, and projections of portions of the two adjacent electrodes overlap, and wherein two signal lines are respectively located on a left side and a right side of the plurality of electrodes, such that one of the two signal lines on the left side is electrically connected to electrodes offset to the left, and the other of the two signal lines on the right side is electrically connected to the electrodes offset to the right; and
a signal transmission element disposed on a side of the encapsulation layer opposite to the sensing section, wherein the signal transmission element includes at least one coil and two transmission lines electrically connected to the at least one coil, and wherein the two transmission lines are electrically connected to the two signal lines.

2. The biological information sensing device as claimed in claim 1, wherein each two adjacent electrodes have an overlap length and are spaced from each other by a spacing, wherein the spacing and the overlap length define an overlap area, and wherein the two electrodes and the overlap area are equivalent to a capacitor.

3. The biological information sensing device as claimed in claim 2, wherein when the number of the plurality of electrodes is n, n-1 capacitors are formed, and the capacitors are electrically connected in parallel by the two signal lines.

4. The biological information sensing device as claimed in claim 2, wherein the spacing is 0.05-0.25 mm, and the overlap length is 1.5-5.8 mm.

5. The biological information sensing device as claimed in claim 1, wherein the detection element and the signal transmission element are made of biodegradable metal including magnesium, zinc, or iron, and wherein the encapsulation layer is made of biodegradable polymers including polyhydroxybutyrate (PHB) or poly(glycerol sebacate) (PGS).

6. The biological information sensing device as claimed in claim 1, further comprising a signal enhancing element covering the plurality of electrodes of the detection element, wherein the signal enhancing element includes a force application face facing the plurality of electrodes and a force reception face opposite to the force application face, and wherein the force reception face faces the to-be-tested object.

7. The biological information sensing device as claimed in claim 6, wherein a plurality of particles is distributed on the force application face and is in contact with the plurality of electrodes and dielectrics in an area of the plurality of electrodes.

8. The biological information sensing device as claimed in claim 7, wherein each of the plurality of particles has a width of 30-50 μm, and wherein a distance between two adjacent particles is 40-60 μm.

9. The biological information sensing device as claimed in claim 7, wherein each of the plurality of particles is a quadrilateral pyramid and has a height of 15-70 μm and a surface inclination angle of 30-70 degrees.

10. The biological information sensing device as claimed in claim 6, wherein the signal enhancing element is made of biodegradable polymers including polyhydroxybutyrate (PHB) or poly(glycerol sebacate) (PGS).
